(19) United States
(12) Patent Application Publication
(10) Pub. No.: US 2023/0343232 A1
(43) Pub. Date: Oct. 26, 2023

(54) A METHOD AND A SYSTEM FOR MONITORING AIRCRAFT

(71) Applicant: SkyNet Satellite Communications Pty Ltd, Newmarket QLD (AU)

(72) Inventor: Jonathan Davis, Newmarket (AU)

(73) Assignee: SkyNet Satellite Communications Pty Ltd, Newmarket QLD (AU)

(21) Appl. No.: 18/027,436

(22) PCT Filed: Sep. 21, 2021
(86) PCT No.: PCT/AU2021/051097

§ 371 Date: Mar. 21, 2023

(30) Foreign Application Priority Data
Sep. 21, 2020 (AU) 2020903370

(51) Int. Cl. G08G 5/04; G08G 5/02; G08G 5/00

(52) U.S. Cl. CPC G08G 5/045; G08G 5/025; G08G 5/0026; G08G 5/006; G08G 5/0082; G08G 5/0013

(57) ABSTRACT

A method and a system for monitoring aircraft including at least one server, the method comprising the steps of: receiving, with a receiver, position data from an aircraft; maintaining a database comprising one or more pieces of data corresponding to a landing site; calculating, with a processor, one or more potential vectors of the aircraft based on the received position data and the one or more pieces of data corresponding to the landing site; determining, with the processor, a probability the aircraft is approaching the landing site based on the one or more potential vectors of the aircraft; identifying, with the processor, a potential for conflict between the aircraft and the landing site based on the probability the aircraft is approaching the landing site and the one or more pieces of data corresponding to the landing site; and activating, with a controller, an alert system based on the potential for conflict determined by the processor, wherein activation of the alert system alerts the landing site of the aircraft approaching the landing site and/or the aircraft of the potential for conflict between the aircraft and the landing site, wherein the receiver, the processor, the controller and the alert system are in communication with one another.

### TECHNICAL FIELD

The present invention relates to a method and a system for monitoring aircraft. More particularly, the present invention relates to a method and a system for monitoring an aircraft and alerting the landing site and/or the aircraft of the potential for conflict between the aircraft and the landing site.

### BACKGROUND

Unscheduled aircraft landing at airfields is unfortunately common and may result in potential conflict between incoming aircraft and ground personnel. In particular, remote airports may receive many types of nonregular flights (such as Fly-In Fly-Out operations, private charters, or the like) or unexpected arrivals (such as emergencies and medical flights, delayed aircraft) with arrivals and departures nearly matching volumes of some metropolitan airports. All airport runways need maintenance, and this includes pavement repairs, lights, grass mowing, etc. These unexpected arrivals can easily go unnoticed in noisy maintenance activities.

In addition, helipads on oil and gas platforms or Floating Production Storage and Offloading (IPSO) and Floating Storage and Offloading (FSO) systems are particularly at risk. Sometimes, rigs may be less than a kilometre apart. If pilots fail to differentiate the helipads of nearby identical rigs in low light or bad weather, it can cause catastrophic accidents. Obstruction from cranes, jibs, equipment, parked helicopters and maintenance personnel are just some ways major incidents can occur in what are already highly hazardous and flammable locations.

Further, at some hospital and oil and gas platform helipads, limited or no accurate information is available about an arriving helicopter. Clinical staff may not be aware of the estimated landing time of the aircraft without any intervention or communication with the aircraft or air traffic providers. As a result, inaccurate landing time information may potentially cause delays in providing support to patients with time-critical injuries. In addition, firefighting systems and personnel trained in its use must be on station for every arrival in case of incident, accident, or fire. However, unscheduled aircraft arrivals or inaccurate landing time information may result in a delay in the deployment of firefighting personnel and equipment, potentially causing delays in providing support to patients with time-critical injuries.

Busy airports with large air traffic control centres have teams of people directing aircraft on the ground (such as taxiways, inactive runways, holding areas, intersections, aprons, etc.) and through airspace (such as approach control, active runways, take-off and landing, route clearance, etc.). However, remote airports and helipads on oil and gas platforms or FPSO/FSO systems may have inadequate numbers of personnel or experienced personnel to physically handle unscheduled aircraft.

Runway and helipad incursions are the cause of some of the world's deadliest aviation accidents. They can happen anywhere, especially on remote helipads and at major international airports under strict control. For example, the UK Civil Aviation Authority concedes that unreported ‘wrong deck landings’ may have occurred 180 times through the 1990s just for oil and gas rigs within its jurisdiction. In the North Sea alone, public reports of pilots landing on—or making approaches to—the wrong helidecks without warning arose in 2014, 2017 and twice in 2019. In addition, Federal Aviation Administration data includes reports of people wandering onto a runway, moments before a plane is scheduled to land, a driver of an airport snow removal truck crossing a runway in front of an incoming plane, and a dump truck coming within roughly 20 yards of colliding with a departing plane in Wisconsin airports.

Thus, there would be an advantage if it were possible to provide an improved method and system for monitoring an aircraft that ameliorates the aforementioned problems.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a method and system for monitoring an aircraft, which may at least partially overcome at least one of the abovementioned disadvantages or provide the consumer with a useful or commercial choice.

It will be understood that the term “aircraft” as used herein may include any aerial vehicle including fixed wing aircraft, rotary wing aircraft, Vertical Take-Off and Landing aircraft, airships, including manned and unmanned aircraft.

It will be understood that the term “landing site” as used herein is intended to refer to any suitable land or structure used for the take-off and landing of an aircraft, such an airfield, an aerodrome, a heliport or the like, but may refer to any suitable landing point used for the take-off and landing of an aircraft, such as a runway, a helipad, a helideck, or the like.

It will be understood that the term “monitoring” an aircraft as used herein may refer to the detection and the tracking of an aircraft making a landing approach to a landing site.

According to a first aspect of the present invention, there is provided a system for monitoring aircraft comprising a server, including:
a receiver configured to receive position data from an aircraft, the receiver associated with a database comprising one or more pieces of data corresponding to a landing site;
an alert system configured to alert the landing site of the aircraft approaching the landing site and/or alert the aircraft of the potential for conflict between the aircraft and the landing site;
a processor coupled to the receiver and coupled to a controller in communication with the alert system;
a memory, coupled to the processor, the memory including instruction code executable by the processor for:
   calculating one or more potential vectors of the aircraft based on the position data and the one or more pieces of data corresponding to the landing site;
   determining a probability the aircraft is approaching the landing site based on the one or more potential vectors;
   identifying a potential for conflict between the aircraft and the landing site based on the probability the aircraft is approaching the landing site and the one or more portions of data corresponding to the landing site; and
   sending one or more commands to the controller to activate the alert system.

According to a second aspect of the present invention there is provided a method for monitoring aircraft including at least one server, the method comprising the steps of:
receiving, with a receiver, position data from an aircraft;
maintaining a database comprising one or more pieces of data corresponding to a landing site;
calculating, with a processor, one or more potential vectors of the aircraft based on the received position data and the one or more pieces of data corresponding to the landing site;
determining, with the processor, a probability the aircraft is approaching the landing site based on the one or more potential vectors of the aircraft;
identifying, with the processor, a potential for conflict between the aircraft and the landing site based on the probability the aircraft is approaching the landing site and the one or more pieces of data corresponding to the landing site; and
activating, with a controller, an alert system based on the potential for conflict determined by the processor, wherein activation of the alert system alerts the landing site of the aircraft approaching the landing site and/or the aircraft of the potential for conflict between the aircraft and the landing site,
wherein the receiver, the processor, the controller and the alert system are in communication with one another.

The receiver may be of any suitable form. For instance, the receiver may be a primary surveillance radar, a secondary surveillance radar, an automatic dependent surveillance system (ADS), a radio receiver, or the like. However, it will be understood that the type of receiver used may vary depending on the type of information transmitted by the aircraft. For instance, the receiver may receive a reflected return from a radar pulse, a return signal from a transponder of an aircraft in response to a radar pulse, a transmission from an aircraft, a radio signal, an audio transmission, an electronic transmission, or the like.

In a preferred embodiment of the invention, the receiver may be configured to receive position data from an ADS system. Any suitable ADS system may be used. Preferably, the ADS system may be an ADS-Broadcast system.

In some embodiments of the invention, the receiver may be adapted to convert the position data received from the aircraft into a format readable by the processor.

The receiver may be configured to receive position data from an aircraft in real-time. In this instance, it will be understood that the receiver may be receiving an essentially live feed of the position data from the aircraft. However, it will be understood that whether the position data is real-time position data may vary depending on the transmission frequency of the position data by the aircraft and whether the aircraft is transmitting data in real-time.

In some embodiments of the invention, the receiver may receive position data from an aircraft semi-autonomously, or autonomously. In some embodiments of the invention, the receiver may receive position data from an aircraft automatically. In this instance, it will be understood that the operation of the receiver may be independent of the processor. In some embodiments of the invention, the processor may be able to switch the receiver from receiving data automatically to being controlled by the processor. In this instance, it is envisaged that the processor may be able to cause the receiver to obtain position data from an aircraft according to any suitable pattern. For instance, the position data may be acquired at regular or irregular intervals of time, at pre-determined time intervals, in response to detecting a signal, continuously, on an ad hoc basis, or any suitable combination thereof. In some embodiments, a user may be able to switch the receiver from being controlled autonomously to being user controlled.

Any suitable position data may be received from the aircraft. For instance, the position data may include aircraft identity information (such as aircraft address and flight identification information), radar data, location, altitude, vector, velocity, vertical rate change, flight level, aircraft status (such as aircraft load weight and fuel weight), or the like. In some embodiments of the invention, the position data received from the aircraft may comprise metadata. For instance, the position data may include metadata associated with the aircraft, a transmitter of the aircraft, a sensor associated with a flight instrument, or the like.

In some embodiments of the invention, the position data received from an aircraft by the receiver may be stored in a data storage associated with the receiver. The data storage associated with the receiver may be transitory, that is the position data may be temporarily stored in the data storage until it may be transferred to the processor. Alternatively, the position data may be permanently stored in the data storage associated with the receiver. In some embodiments of the invention, the position data received from an aircraft may be stored in a database associated with the system. In this instance, it is envisaged that the processor may be in communication with the database and may obtain the position data from the database. In some embodiments of the invention, the database may be located in relatively close proximity to the system or may be positioned remotely from the system.

The system for monitoring aircraft may be associated with a database, wherein the database comprises one or more pieces of data corresponding to a landing site. Any suitable data may be stored in the database. For instance, the data may comprise details of operations to be undertaken at the landing site (such as inspections, maintenance, cleaning, or the like), availability and condition of runways, helipads, or the like at the landing site (such as presence of parked aircraft, obstructions, inoperative lighting, damaged surfaces, or the like), operating capabilities at the landing site (such as runway length, load bearing capacity, night landing facilities, or the like), environmental conditions (such as weather conditions, visibility, weather forecasts, or the like), scheduled arrival and departure plans for the landing site, airport movement procedures, safety protocols (such as deployment of firefighting systems or other emergency services), or the like. In a preferred embodiment of the invention, the database comprises one or more pieces of data corresponding to operations to be undertaken at the landing site by ground personnel at the landing site. In this instance it is envisaged that the data may include the type of operation being undertaken, a schedule of activities that need to be undertaken, the dates and times of the activities, the personnel and equipment required, whether all or part of the landing site is inoperative or operating at reduced capacity, or the like.

It will be understood that the term “maintaining” the database may include any suitable method of providing the database with one or more pieces of data relevant to the operation of the system and the objective of monitoring an aircraft and alerting the landing site and/or the aircraft of the potential for conflict between the aircraft and the landing site and ensuring the one or more pieces of data are up to date. In some embodiments of the invention, the database may be maintained externally to the system for monitoring an aircraft. In this instance, it is envisaged that the processor may be in communication with the database and may obtain the one or more pieces of data corresponding to the landing site from the database.

The system for monitoring aircraft includes at least one processor and at least one non-transitory computer readable storage medium storing instructions thereon that, when executed by the at least one processor to monitor an aircraft. Preferably, the at least one processor may be in communication with the receiver and the database. The at least one processor may be the same type of processor, or, alternatively, may be of different types. However, it will be understood that the type of processor may vary depending on a number of factors, including the operation to be performed by the processor.

Any suitable processor may be used. For instance, the processor may be a microprocessor, an integrated circuit, a chip, a microchip, a system on a chip, or the like. Preferably however, the processor may be capable of receiving position data from an aircraft and analysing the combination of distance, speed, altitude, and heading to determine the probability of an aircraft approaching to land and providing early warning of the potential conflict between incoming aircraft and the landing site (such as to ground personnel or equipment).

In an embodiment of the invention, the system may be configured to monitor an aircraft semi-autonomously. In a preferred embodiment of the invention, the system may be configured to monitor an aircraft autonomously. Preferably, the system may monitor an aircraft by a processor comprising an intelligent agent. It is envisaged, that in use, an intelligent agent or a processor comprising an intelligent agent may comprise artificial intelligence, machine learning algorithms, deep learning models, computer vision algorithms, and the like. In an embodiment of the invention, the processor may comprise an intelligent agent, wherein the intelligent agent comprises one or more sub-agents configured to perform the different operations required to monitor an aircraft.

Preferably, the processor is in electronic communication with the receiver. The receiver may be in electronic communication with the processor using any suitable technique. In some embodiments of the invention, the receiver may be physically connected to the processor (for instance, by being built into the processor or by being attached to the processor via one or more cords, wires, cables of the like). Alternatively, the receiver may be in wireless electronic communication with the processor, such as via a Wi-Fi connection, Bluetooth connection, or the like. In some embodiments of the invention, the processor and the receiver may be located in close proximity to one another, or located remotely from one another.

Preferably, the processor is in electronic communication with the database. The processor may be in electronic communication with the database using any suitable technique. In some embodiments of the invention, the processor may be physically connected to the database (for instance, by being built into the processor or by being attached to the processor via one or more cords, wires, cables of the like. Alternatively, the processor may be in wireless electronic communication with the database, such as via a Wi-Fi connection, Bluetooth connection, or the like. In some embodiments of the invention, the processor and the database may be located in close proximity to one another, or located remotely from one another. In use, it is envisaged that the processor may obtain one or more pieces of data corresponding to the landing site from the database during processing of the position data received from the aircraft.

In some embodiments of the invention, the processor may store data and/or information on the database associated with system. Alternatively, the processor may be provided with its own data storage. Preferably, the processor may be in communication with at least one non-transitory computer readable storage medium storing instructions thereon that, when executed by the at least one processor to monitor an aircraft.

The processor may obtain any suitable data and/or information from the database and/or the data storage. For instance, the data and/or information may include instructions or rules, one or more predetermined rules relating to the task to be performed, programs and algorithms for the processor, training data to aid in machine learning, data from other landing sites (and particularly analogous landing sites), data associated with historical potential or actual conflicts from the landing site, data associated with potential or actual conflicts from other landing sites, processed and unprocessed data generated by the processor, or the like.

It is envisaged that in use, data collected while monitoring an aircraft as well as the computer-generated data may be used by the processor to improve monitoring of aircraft. By this, it is meant monitoring of aircraft may be improved, by, for example improving the accuracy of calculating potential vectors of an aircraft from the landing site, improving the prediction of the probability the aircraft is approaching the landing site, improving the identification of a potential of conflict between the aircraft and the landing site, etc.

The processor may calculate one or more potential vectors of the aircraft based on the received position data and the one or more pieces of data corresponding to the landing site using any suitable technique. In use, it is envisaged that the processor may analyse the combination of distance, speed, altitude, and heading obtained from the received position data to determine one or more potential vectors and/or one or more estimated landing times for the aircraft. In some instances, the processor may use aircraft identity information to determine one or more potential vectors and/or one or more estimated landing times for the aircraft.

Preferably, the processor may obtain one or more pieces of data corresponding to the landing site from the database during processing of the position data of the aircraft and use this information when calculating the one or more potential vectors. For instance, the processor may obtain position data associated with the landing site, weather conditions including wind direction and speed, position data associated with nearby landing sites, or any suitable combination thereof from the database. In this instance, it is envisaged that the one or more pieces of data obtained from the database may be used to improve the accuracy of the calculated potential vectors or determine alternative potential vectors.

In use, it is envisaged that the one or more potential vectors of the aircraft and/or the one or more estimated landing times may be updated using updated position data from the aircraft. The one or more potential vectors and/or one or more estimated landing times may be updated at regular or irregular intervals of time, at pre-determined time intervals, in response to detecting a signal, continuously, on an ad hoc basis, or any suitable combination thereof. In some embodiments of the invention, a user may be able to trigger the processor to update the one or more potential vectors and/or one or more estimated landing times manually.

The processor may determine the probability the aircraft may be approaching the landing site based on the one or more potential vectors of the aircraft using any suitable technique. However, it is envisaged that the processor may use the one or more potential vectors in combination with position data obtained from the aircraft and one or more pieces of data obtained from the database to determine the probability the aircraft may be making an approach to the landing site and/or may be in a landing configuration.

For instance, the position data obtained from the aircraft may include the speed, altitude, vertical speed (rate of ascent or descent), and direction of travel of the aircraft, or the like. For instance, the position data may include information such as whether the landing gear of the aircraft is down, flaps are deployed, or the like. In some embodiments, the position data may comprise calculated position data. For instance, the vertical speed may be calculated from position data such as speed or altitude obtained from the aircraft.

For instance, the data obtained from the database may include the type and location of other nearby landing sites, filed flight plans, departure information, known performance criteria of the type of aircraft, or the like. For instance, the data obtained from the database may include an approach corridor, vector approach configuration, centre line of the runway, or the like. In this instance, it will be understood that the approach corridor or vector approach configuration are generally cone-shaped funnels that contain the normal approaches for a runway, helipad or the like. Advantageously, using the approach corridor or vector approach configuration may extend the capability of the system to provide early warning of an aircraft making an approach to the landing site, and/or in a landing configuration. For instance, the system may provide early warning of an unscheduled aircraft at about 15 or 20 nautical miles from the landing site, thereby increasing the early warning by 5 minutes or more.

The probability the aircraft may be approaching the landing site may be updated in light of updated potential vectors of the aircraft and/or by using updated position data from the aircraft to validate/invalidate one or more potential vectors of the aircraft. The probability the aircraft may be approaching the landing site may be updated at regular or irregular intervals of time, at pre-determined time intervals, in response to detecting a signal, continuously, on an ad hoc basis, or any suitable combination thereof. In some embodiments of the invention, a user may be able to trigger the processor to update the probability the aircraft may be approaching the landing site manually.

The processor may identify a potential for conflict between the aircraft and the landing site based on the probability the aircraft is approaching the landing site and the one or more pieces of data corresponding to the landing site using any suitable technique.

For instance, the processor may analyse one or more pieces of data corresponding to the landing site to determine if an operation (such as inspections, maintenance, cleaning, or the like) is presently underway or planned that may result in ground personnel potentially being present in the vicinity of a landing aircraft or may result in the unavailability or reduced capability of a runway, a helipad, or the like (such as undeployed firefighting systems, landing site occupied, reduced load bearing capability of the landing site, weather conditions, or the like) towards which the landing aircraft is heading.

For instance, the processor may analyse one or more pieces of data corresponding to the landing site (such as filed flight plans, or the like) to determine if an unscheduled aircraft is approaching the landing site and/or if an aircraft is approaching an incorrect runway, helipad, or the like at a landing site.

In an embodiment of the invention, the system for monitoring aircraft comprises a controller in communication with the processor and an alert system, the controller configured to activate the alert system based on the potential for conflict determined by the processor. In use, it is envisaged that the processor may be configured to send one or more commands to the controller to activate the alert system. In particular, it is envisaged that the one or more commands may identify specific types of alert (such as visual, audible, radio, bird soarers, or the like) and the extent of the alert (such as part or all of the landing site, individual personnel or groups of personnel, services located remotely to the landing site, the aircraft only, or the like) to be activated. In addition, the processor may send one or more commands to the controller to change the type and extent of the alert based on the type of potential conflict (such as risk to ground personnel, natural hazards, risk to aircraft) and whether the potential conflict is escalating or de-escalating.

In some embodiments of the invention, the processor may send one or more commands to the controller to activate one or more alert systems.

For instance, the processor may identify a potential for conflict between an aircraft and birdlife at the landing site which results in the processor transmitting a command to the controller to activate a bird scarer located in proximity to the active runways.

For instance, the processor may identify an increased potential for conflict between an aircraft and ground personnel undertaking maintenance work as the aircraft is about 2.5 to about 5 minutes from the landing site, or has entered either the 5 nautical mile alert radius or an alert approach corridor about the landing site and the processor transmits a command to the controller to escalate the alert from automated messages on two-way radios to activating sirens and strobe lights at the landing site.

For instance, the processor may identify a potential for conflict between an aircraft and a landing site due to a helicopter attempting to land on the wrong platform and the processor may transmit a command to the controller to activate warning or wave-off beacons on the platform and to transmit automated messages to the helicopter.

For instance, the processor may identify a potential for conflict between an air ambulance and a helipad on a hospital site, due to undeployed firefighting systems on the helipad and the processor may transmit a command to the controller to alert firefighting personnel to attend the helipad.

Any suitable controller may be used. For instance, the controller may be a microcontroller, an integrated circuit, an expansion card, a chip, a microchip, a system on a chip, or the like. In use, it is envisaged that the controller may be used to interface between the processor and the alert system to relay one or more commands to the alert system.

In an embodiment of the invention, the controller may be configured to activate the alert system semi-autonomously. In a preferred embodiment of the invention, the controller may be configured to activate the alert system autonomously. In this instance, it will be understood that the operation of the controller in activating the alert system may be independent of the processor. In some embodiments of the invention, the processor may be able to switch the controller from activating the alert system automatically to being controlled by the processor. In some embodiments, a user may be able to switch the controller from activating the alert system autonomously to being user controlled.

The alert system may be of any suitable type. Preferably, the alert system may be configured to alert the landing site of the aircraft approaching the landing site and/or alert the aircraft of the potential for conflict between the aircraft and the landing site. However, it will be understood that the type of alert system used may vary on a number of factors including who or what is being alerted and whether the potential conflict is escalating or de-escalating.

For instance, where the landing site is being alerted of an approaching aircraft then the alert system may comprise alerting ground personnel by pager message, text message, automated message over a two-way radio, user interface on an electronic device, activating a siren or other audible alarm, activating strobe lights, or the like. In this instance, it will be understood that the alert system may serve to alert ground personnel that may be in conflict with the approaching aircraft, or must be in attendance for a landing of an aircraft.

For instance, where the potential conflict is due to birds or wildlife on the runways, the alert system may comprise bird scarers, or the like.

For instance, where the aircraft is being alerted of the potential conflict between the aircraft and the landing site, the alert system may comprise changing the approach or runway lighting pattern, activating warning or wave-off beacons or a the landing site, activating obstruction lights on ground equipment, or the like.

In use, it is envisaged that, the type of alert may be changed depending on whether the potential for conflict is escalating or de-escalating. In some embodiments, the type of alert may remain the same, but the frequency, duration, or degree may change as a result of the escalating or de-escalating circumstances. In other embodiments, the type of alert may change from one type to another type as a result of the escalating or de-escalating circumstances.

In an embodiment of the invention, the system for monitoring aircraft comprises one or more electronic devices in communication with one or more of the receiver, the database, the processor, the controller and the alert system. The one or more electronic devices may be located in relatively close proximity to the system or may be positioned remotely from the system.

Any suitable electronic device may be used. For instance, the electronic device may comprise a laptop computer, a desktop computer, a tablet computer, a smart phone, a mobile telephone, a screen, a display device, a terminal, a hand-held device, a head-mounted display, or the like. The electronic device may be configured to enable a user to receive an alert from the alert system, display information from the system for a user to monitor aircraft, to enable a user to interact with the displayed information, to enable a user to interact with the system, or any suitable combination thereof.

Preferably, the system for monitoring aircraft may be provided with one or more user interfaces that may be displayed on the display of the electronic device. In some embodiments, all users may access the same user interface. In other embodiments of the invention, the user interface that a user may access may be determined by the level of access granted to that user. In this instance, it is envisaged that what a user interface allows a user to do within the system for monitoring aircraft will be limited to only the relevant functionality for the user's level of access.

In some embodiments of the invention, a user may use an electronic device to intervene in the operation of the system, for instance, to request the receiver obtain updated position data from an aircraft, to provide updated one or more pieces of data to the database, to provide reference or training data to the processor, to provide updated rules or instructions to the processor and/or controller, to manually alert the landing site of the aircraft approaching the landing site and/or alert the aircraft of the potential for conflict, and so on. It is envisaged that the user may be able to switch the system between being user controlled and being operated autonomously. In some embodiments of the invention, a user may use the electronic device to send copies of the alerts via electronic communications (such as emails, text messages, or the like) to a user device associated with ground personnel.

In some embodiments of the invention, a user may display, with an electronic device, the position data from the aircraft and one or more of the data corresponding to the landing site, the potential vectors of the aircraft, and the probability the aircraft is approaching the landing site.

In some embodiments of the invention, a user may use the electronic device to obtain logged landing data associated with one or more aircraft for the landing site from the system. For instance, the logged landing data may include aircraft identity information, received position data, landing time, time on ground, or the like. In use, it is envisaged that a user at a remote or unmanned airport may use the logged landing data to levy charges based on time spent on the ground.

In some embodiments of the invention, a user may use the electronic device to receive alerts of approaching aircraft and/or to display information from the system including position data from an aircraft, estimated landing time of the aircraft, and the like. For instance, clinical staff at a hospital may be alerted to an approaching aircraft by an application installed on a personal electronic device and may use the system to monitor the estimated landing time of the aircraft. For instance, firefighting personnel may receive an automated alert message by the system to an approaching aircraft.

In an embodiment of the invention, the system may be configured to transmit data and/or information from the processor to the aircraft. For instance, the system may transmit instructions to the aircraft, one or more pieces of data corresponding to the landing site (such as landing site status, weather conditions, or the like), voice messages from air traffic control, traffic information, or the like. However, it will be understood that the type of data and/or information transmitted to the aircraft may vary depending on the type of receiver used in the aircraft.

The present system and method provides a number of advantages over the prior art. For instance, the present system and method assists in managing traffic, reducing the chances of an aircraft landing in the wrong place and improving management of unscheduled aircraft. Further, the system and method may improve ground personnel safety by providing early warning of an unscheduled aircraft allowing ground personnel to clear the landing area and prepare for the aircraft landing. In addition, the present system and method assists in managing natural hazards, such as birds and other wildlife, on airfields by activating automatic bird scarers.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a representation of a method for monitoring aircraft according to an embodiment of the present invention.

FIG. 2 illustrates a system for monitoring aircraft according to an embodiment of the present invention.

FIG. 3 illustrates a representation of a display generated by the system for monitoring aircraft according to an embodiment of the invention.

FIG. 4 illustrates a representation of a display generated by the system for monitoring aircraft according to any embodiment of the invention.

### DESCRIPTION OF EMBODIMENTS

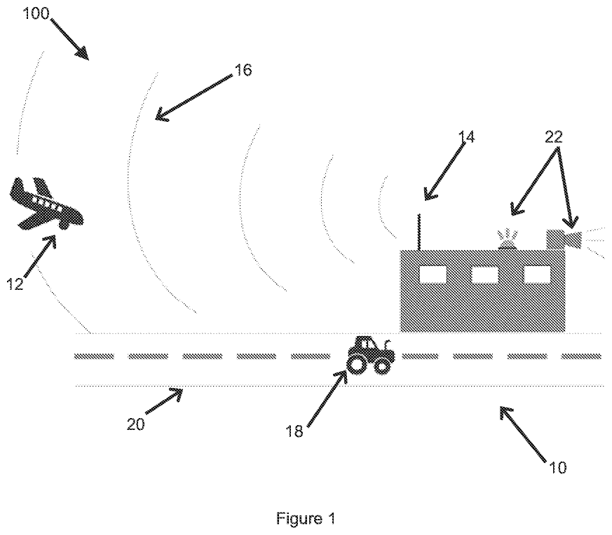

In FIG. 1, a representation of a method for monitoring aircraft 100 according an embodiment of the invention is illustrated. Landing site 10 may be provided with a system for monitoring aircraft 12, the system comprising a receiver 14 configured to receive position data 16 transmitted by aircraft 12, at least one processor (not shown) and at least one non-transitory computer readable storage medium (not shown) storing instructions thereon.

Processor (not shown) may calculate one or more potential vectors from landing site 10 of aircraft 12 based on received position data 16 and one or more pieces of data corresponding to the landing site 10 obtained from database (not shown). In use, it is envisaged that the processor may analyse the combination of location, distance, speed, altitude, and heading obtained from received position data 16 of the aircraft and data such as latitude and longitude of the runway of landing site 10 to determine one or more potential vectors for aircraft 12.

Preferably, the processor may calculate the bearing to and/or from the aircraft to the landing site using the latitude and longitude of each of the aircraft and the landing site and the Global Positioning System (GPS) received speed of the aircraft to calculate a potential vector and an estimated landing time of the aircraft.

The processor may use additional data obtained from the landing site, such as wind direction and speed to improve the accuracy of the calculated potential vectors or determine alternative potential vectors.

The processor determines the probability aircraft 12 may be approaching landing site 10 based on the one or more potential vectors of the aircraft 12 in combination with position data 16 (such as speed, altitude, rate of descent, direction of travel, etc.) obtained from aircraft 12 and one or more pieces of data obtained from the database (such as the location of nearby landing sites, filed flight plans, departure information, known performance criteria of the type of aircraft, approach corridor of the landing site, vector approach configuration of the landing site, centre line of the runway, or the like).

Preferably, the processor determines the probability the aircraft may be approaching the landing site by comparing the potential vector of the aircraft with the speed, altitude and/or vertical speed of the aircraft and an approach corridor of the landing site and/or centre line of the runway.

The processor identifies a potential for conflict between aircraft 12 and landing site 10 based on the probability aircraft 12 may be approaching landing site 10 and one or more pieces of data corresponding to landing site 10 obtained from the database. In use, it is envisaged that the processor may analyse one or more pieces of data corresponding to landing site 10 to determine if an operation, such as grass maintenance using a mower 18, is presently underway or planned that may result in ground personnel potentially being present in the vicinity of a landing aircraft or may result in the unavailability or reduced capability of a runway 20, a helipad, or the like towards which a landing aircraft is heading.

The processor sends one or more commands to a controller (not shown) which may activate an alert system 22 based on the potential for conflict determined by the processor. Activation of alert system 22 may alert landing site 10 of the aircraft 12 using, for instance an audible alarm and strobe lights as well as automated two-way radio messages may be used to alert maintenance personnel. In addition, alert system 22 may alert firefighting personnel of the incoming aircraft 12, requesting attendance at the landing site 10.

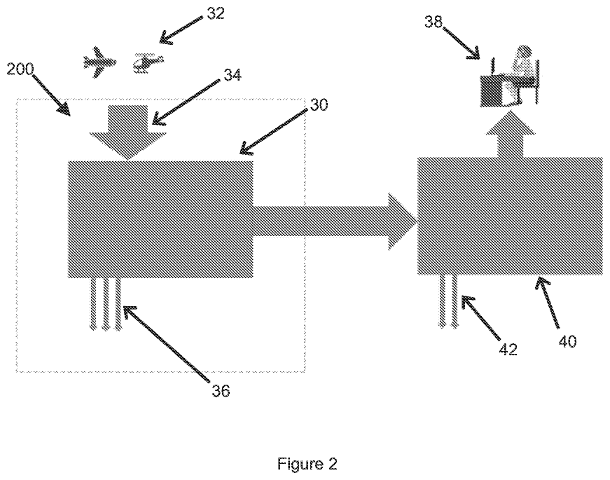

A representation of a system for monitoring aircraft 200 is illustrated in FIG. 2. System 200 including at least one processor 30 and at least one non-transitory computer readable storage medium storing instructions thereon that, when executed by processor 30, cause the system to receive position data 34 associated with an aircraft 32 and obtain one or more pieces of data corresponding to a landing site (not shown) from a database (not shown).

Processor 30 of system 200 is configured to calculate one or more potential vectors from the landing site of aircraft 32, determine the probability aircraft 32 is approaching the landing site and identify a potential for conflict between aircraft 32 and the landing site. Processor 30 of system 200 sends one or more commands to a controller (not shown) in communication with an alert system 36 with instructions to activate the alert system 36 located at the landing site.

A remote user 38 may access system 200 located at the landing site using an electronic device associated with a central server 40 in communication with system 200. Remote user 38 may monitor the landing site and any approach alerts generated by system 200, provide updated data to system 200, obtain logged landing from system 200 for levying charges to users of the landing sites, send copies of alerts 42 to other users, etc.

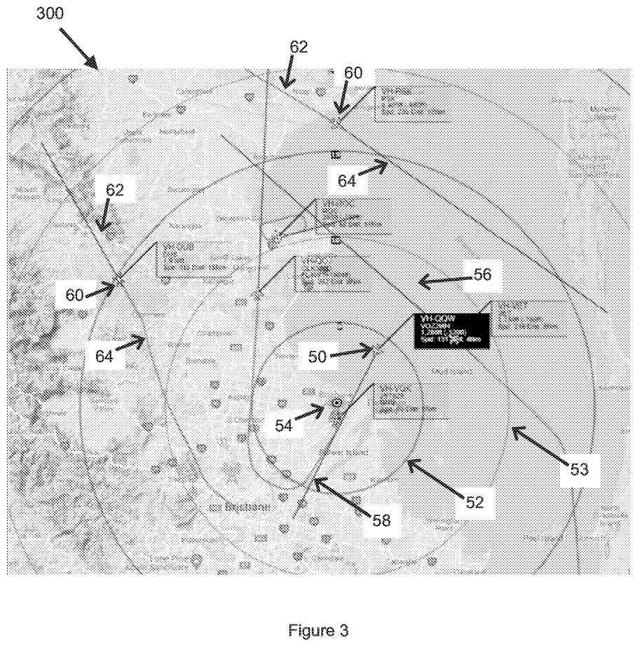

A representation of a display 300 generated by the system for monitoring aircraft and capable of being monitored by a user using an electronic device (not shown) is shown in FIG. 3. The system may track aircraft within a designated airspace about landing site 54 and presents the information on display 300. The processor of the system may monitor the actual path 62 and calculated potential vector 64 of each scheduled aircraft 60.

Unscheduled aircraft 50 may also be monitored, with the actual path 56 taken by unscheduled aircraft 50 and calculated potential vector 58 of the aircraft 50 displayed. As unscheduled aircraft 50 enters the 10 nautical mile alert radius 53, the processor (not shown) may send a command to the controller to activate the alert system, alerting personnel in a landing site control tower to increase monitoring of the unscheduled aircraft and to attempt contact with the pilot. As unscheduled aircraft 50 enters the 5 nautical mile alert radius 52 about landing site 54 and has a vertical speed of greater than −200 metres per second, the processor (not shown) of the system may escalate the alert system alerting ground personnel of the probable landing aircraft.

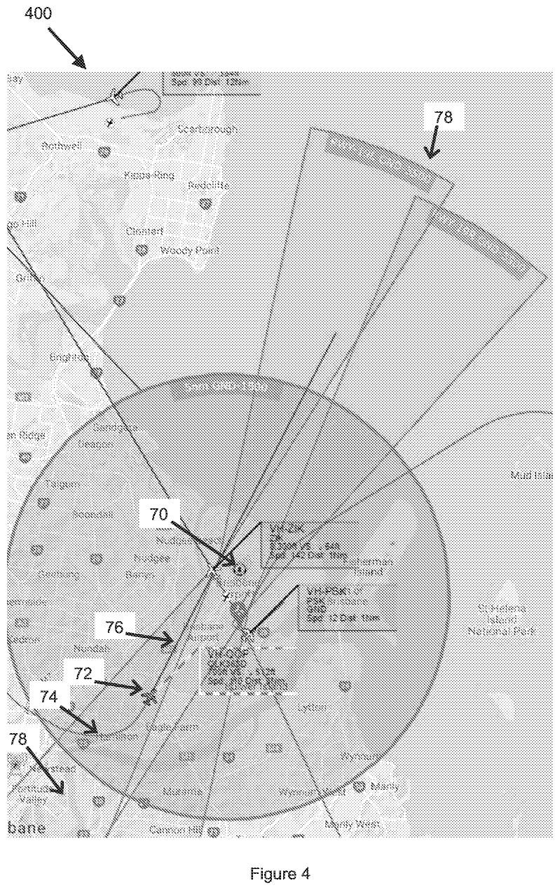

A representation of a display 400 generated by the system for monitoring aircraft and capable of being monitored by a user using an electronic device (not shown) is shown in FIG. 4. The system may track all aircraft within a designated area about landing site 70 and present the information on display 400. The processor of the system may monitor the actual path and calculated vector of each aircraft within the designated area including unscheduled aircraft 72. The actual path 74 of an unscheduled aircraft 72 is monitored, and the calculated potential vector 76 of the aircraft 72 displayed.

As unscheduled aircraft 72 has entered an approach corridor 78 of a runway at landing site 70 and position data received from aircraft 72 indicates it has adopted a landing configuration (such as reduced speed and altitude), the processor (not shown) of the system activates the alert system alerting ground personnel of the probable landing aircraft.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for monitoring aircraft including at least one server, the method comprising the steps of:
receiving, with a receiver, position data from an aircraft;
maintaining a database comprising one or more pieces of data corresponding to a landing site;
calculating, with a processor, one or more potential vectors of the aircraft based on the received position data and the one or more pieces of data corresponding to the landing site;
determining, with the processor, a probability the aircraft is approaching the landing site based on the one or more potential vectors of the aircraft;
identifying, with the processor, a potential for conflict between the aircraft and the landing site based on the probability the aircraft is approaching the landing site and the one or more pieces of data corresponding to the landing site;
activating, with a controller, an alert system based on the potential for conflict determined by the processor, wherein activation of the alert system alerts the landing site of the aircraft approaching the landing site and/or the aircraft of the potential for conflict between the aircraft and the landing site; and
displaying, with an electronic device, the position data from the aircraft and at least one of the one or more pieces of data corresponding to the landing site, the potential vectors of the aircraft, and the probability the aircraft is approaching the landing site;
wherein the receiver, the processor, the controller and the alert system are in communication with one another.

2. (canceled)

3. The method for monitoring aircraft according to claim 1, further comprising the step of:
logging and recording landing data associated with the aircraft for the landing site.

4. The method for monitoring aircraft according to claim 1, wherein the position data is automatic dependent surveillance data associated with the aircraft.

5. The method for monitoring aircraft according to claim 1, wherein the receiver is configured to receive the position data from the aircraft in real-time.

6. The method for monitoring aircraft according to claim 1, wherein activation of the alert system alerts ground personnel that may be in conflict with a landing of the aircraft, or must be in attendance for the landing of the aircraft.

7. The method for monitoring aircraft according to claim 1, wherein the processor comprises an intelligent agent.

8. A system for monitoring aircraft including at least one processor and at least one non-transitory computer readable storage medium storing instructions thereon that, when executed by the at least one processor, cause the system to:
receive position data associated with an aircraft from a receiver;
obtain one or more pieces of data corresponding to a landing site from a database;
calculate one or more potential vectors of the aircraft based on the position data and the one or more pieces of data corresponding to the landing site;
determine a probability the aircraft is approaching the landing site based on the one or more potential vectors;
identify a potential for conflict between the aircraft and the landing site based on the probability the aircraft is approaching the landing site and the one or more pieces of data corresponding to the landing site;
send one or more commands to a controller in communication with an alert system, instructions to activate the alert system, wherein the alert system is configured to alert the landing site of the aircraft approaching the landing site and/or alert the aircraft of the potential for conflict between the aircraft and the landing site, and
display the position data from the aircraft and at least one of the one or more pieces of data corresponding to the landing site, the potential vectors of the aircraft, and the probability the aircraft is approaching the landing site.

9. (canceled)

10. The system for monitoring aircraft according to claim 8, wherein the system is configured to:
log and record landing data associated with the aircraft for the landing site.

11. The system for monitoring aircraft according to claim 8, wherein the system is configured to receive the position data from an automatic dependent surveillance system associated with the aircraft.

12. The system for monitoring aircraft according to claim 8, wherein the system is configured to receive the position data from the aircraft in real-time.

13. The system for monitoring aircraft according to claim 8, wherein activation of the alert system alerts ground personnel that may be in conflict with a landing of the aircraft, or must be in attendance for the landing of the aircraft.

14. The system for monitoring aircraft according to claim 8 any one of claims 8 to 13, wherein the at least one processor comprises an intelligent agent.

15. Use of the method for monitoring aircraft according to claim 1 for monitoring the approach of an unscheduled aircraft to the landing site.

16. Use of the method for monitoring aircraft according to claim 1 for monitoring the approach of an aircraft to the landing site, wherein the landing site is a remote airport, a helipad or a heliport.

17. Use of the system for monitoring aircraft according to claim 8 for monitoring the approach of an unscheduled aircraft to the landing site.

18. Use of the system for monitoring aircraft according to claim 8 for monitoring the approach of an aircraft to the landing site, wherein the landing site is a remote airport, a helipad or a heliport.
